(19) United States
(12) Patent Application Publication
(10) Pub. No.: US 2006/0051089 A1
(43) Pub. Date: Mar. 9, 2006

(54) Communication system linking between user terminals, and user terminal connecting unit and communication method used in same communication system

(75) Inventor: Kiyoshi Muroi, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/218,442

(22) Filed: Sep. 6, 2005

(30) Foreign Application Priority Data
Sep. 6, 2004 (JP) 2004-259063

(51) Int. Cl. H04B 10/20

(52) U.S. Cl. 398/58

(57) ABSTRACT

To provide a communication system in which an increase of connection cables for mutually connecting user terminal connecting units is small, even if the number of user terminal connecting units connected to user terminals increases. In each of the user terminal connecting units, since each data signal y is converted into an optical signal d of a wavelength set uniquely to each unit, is wavelength-division-multiplexed, and is transmitted, the communication system is configured by cascade-connecting the user terminal connecting units via communication cables sequentially. Therefore, even if a user terminal connecting unit is added, an increase of communication cables can be reduced, costs can be reduced, working for adding the unit can be reduced. Also, since transmission of each data signal of each unit is controlled by the optical signal, no communication cable exclusive to the control signal is needed, and each unit can be configured relatively simple.

### BACKGROUND OF THE INVENTION

1. Field of the Invention

The present invention relates to a communication system linking between user terminals, a user terminal connecting unit, and a communication method which are suitable for a intra-corporate communications, such as a intra-corporate local area network, and more especially to a communication system linking between user terminals, a user terminal connecting unit, and a communication method which are suitable for a case in that a network connected with a plurality of user terminals, such as personal computers, is configured in a company or a like.

The present application claims priority of Japanese Patent Application No. 2004-259063 filed on Sep. 6, 2004, which is hereby incorporated by reference.

2. Description of the Related Art

When a network connected with a plurality of user terminals such as personal computers is configured in a company, for example, a communication system provided with a plurality of user terminal connecting units connected to the user terminals and communication lines is used. Each of the user terminal connecting units transmits/receives communication data to/from directed user terminals among the plurality of user terminals and transmits/receives the communication data to/from all of the other user terminal connecting units via the communication lines.

This kind of conventional communication system, as shown in FIG. 7, is provided with N-pieces (N: integer) of user terminal connecting units 10₁, 10₂, . . . , 10_{N}. The user terminal connecting unit 10₁ is provided with M-pieces (M: integer) of interface sections 11₁, 11₂, . . . , 11_{M} and a data switching section 12. The interface sections 11₁, 11₂, . . . , 11_{M} are connected to user terminals such as personal computers not shown. The data switching section 12 is provided with a data multiplexing section 13 and a data distributing section 14. The data multiplexing section 13 is provided with M-pieces of input sections (in FIG. 7, referred to as inputs) 1, 2, . . . , M, and N-pieces of output sections (in FIG. 7, referred to as outputs) 1, 2, . . . , N. The data distributing section 14 is provided with N-pieces of input sections (in FIG. 7, referred to as inputs) 1, 2, . . . , N, and M-pieces of output sections (in FIG. 7, referred to as outputs) 1, 2, . . . , M. The configurations of the user terminal connecting unit 10₂, . . . , 10_{N} are similar to that of the user terminal connecting unit 10₁. In each of the user terminal connecting units 10₁, 10₂, . . . , 10_{N}, (N-1)-pieces of output sections in the data multiplexing section 13 and (N-1)-pieces of input sections in the data distributing section 14 are mutually mesh-connected via respective connection cables.

In this communication system, data signals d₁, d₂, . . . d_{M} from the interface sections 11₁, 11₂, . . . 11_{M} are input to the data multiplexing section 13, and each sub-data is transmitted from each of the output sections 2, . . . , N to each of user terminal connecting units 10₂, . . . , 10_{N} corresponding to an address of sub-data in each data signal. Data signals from the user terminal connecting user terminal connecting units 10₁, 10₂, . . . 10 _{N} are input to the data distributing section 14, and each sub-data is output from each of the output sections 1, 2 . . . M to the interface sections 11₁, 11₂, . . . , 11_{M} corresponding to each address of each sub-signal in each data signal. In each of the user terminal connecting units 10₁, 10₂, . . . , 10_{N}, (N-1)-pieces of output sections in the data multiplexing section 13 and (N-1)-pieces of input sections in the data distributing section 14 are mutually mesh-connected via respective connection cables. Hence, data is mutually switched among the interface sections 11₁, 11₂, . . . , 11_{M} in all of the user terminal connecting units 10₁, 10₂, . . . , 10_{N}.

FIG. 8 is a schematic block diagram showing another conventional communication system.

The communication system, as shown in FIG. 8, is provided with N-pieces (N: integer) of user terminal connecting units 20₁, 20₂, . . . , 20_{N} and a common unit 30. The user terminal connecting unit 20₁ is provided with M-pieces (M: integer) of interface sections 21₁, 21₂, . . . , 21_{M} and a data switching section 22. The interface sections 21₁, 21₂, . . . , 21_{M} are connected with user terminals such as personal computers not shown. The data switching section 22 is provided with a data multiplexing section 23 and a data distributing section 24. The data multiplexing section 23 is provided with M-pieces (M: integer) of input sections (in FIG. 8, referred to inputs) 1, 2, . . . , M and an output section F. The data distributing section 24 is provided with an input section G and M-pieces (M: integer) of output sections (in FIG. 8, referred to as outputs) 1, 2, . . . , M. Configurations of the user terminal connecting units 20₂, . . . , 20_{M} are the same as those of the user terminal connecting unit 201 and their description has been omitted for brevity. The common unit 30 is provided with a data switching section 31. The data switching section 31 is provided with N-pieces of input sections (in FIG. 8, referred to inputs) 1, 2, . . . , N, and N-pieces of output sections (in FIG. 8, referred to as outputs) 1, 2, . . . , N.

In this communication system, in the user terminal connecting units 20₁, 20₂. . . 20_{M}, data signals d₁, d₂ . . . , d_{M} from the interface sections 21₁, 21₂. . . 21_{M} are input to the data multiplexing section 23 and are multiplexed. Multiplexed data e₁, e₂. . . , e_{N} are sent to the data switching section 31 in the common unit 30. In the data switching section 31, each of sub-data f₁, f₂, . . . , f_{N} is output to the data distributing section 24 in each of the user terminal connecting units 20₁, 20₂, . . . , 20_{N} corresponding to an address of each sub-data in each of the multiplexed data e₁, e₂ . . . , e_{N}. Data is mutually switched among the interface sections 21₁, 21₂, . . . , 21_{N} in all of the user terminal connecting units 20₁, 20₂, . . . , 20_{N}.

In addition to the above-described communication systems, a technique like this is disclosed, for example, in Japanese Patent Application Laid-open No. 7-307739.

In the communication system disclosed in Japanese Patent Application Laid-open No. 7-307739, by repeatedly transmitting line allocation information (service condition information) of multiplex lines among a plurality of nodes to each node by a light having a wavelength different from those of multiplexed lights, respective nodes share the line allocation information. In each node, based on the line allocation information, a wavelength of light to be transmitted or to be received is selected. A control section for collecting and distributing the line allocation information is arranged in a concentrator independent from each node.

However, in the above-described communication systems, there are following problems.

More specifically, in the communication system shown in FIG. 7, since it is necessary to arrange the same number of output sections 1, 2, . . . , N as each user terminal connecting unit 10k (k: 1, 2, . . . , N) in the data multiplexing section 13 and to arrange the same number of input sections 1, 2, . . . , N as each user terminal connecting unit 10k in the data distributing section 14, the data multiplexing section 13 and the data distributing section 14 become complicated. Also, since the (N-1)-pieces of output sections in the data multiplexing section 13 and the (N-1)-pieces of input sections in the data distributing section 14 in each user terminal connecting unit 10k are mutually mesh-connected, the number of connection cables is two when the number of units is two, the number of connection cables is six when the number of units is three, or the number of connection cables is (N-1)×N-pieces when the number of units is N-pieces. Therefore, a larger number of connection cables are required as the number of user terminal connecting units 10k increases. Also, when a user terminal connecting unit 10k is added, work for adding connection cables becomes complicated.

Also, in the communication system shown in FIG. 8, regardless of the number of user terminal connecting units 20k (k: 1, 2, . . . , N), the common unit 30 is necessary, and it is necessary to arrange the same number of input sections 1, 2, . . . , N and output sections 1, 2, . . . , N as the maximum number of the user terminal connecting units 20k in the data switching section 31 of the common unit 30, and therefore, the common unit 30 becomes complicated. Further, the data signal transmission speed in the input sections 1, 2, . . . , N and the output sections 1, 2, . . . , N requires a transmission capacity of each user terminal connecting unit 20k, the total transmission capacity set for the common unit 30 requires N×N times of the transmission capacity of each user terminal connecting unit 20k. In this case, in an early stage where the communication system is introduced, there are few cases in that all of user terminal connecting units 20k are arranged, and therefore, the common unit 30 is wasted.

Further, the communication system disclosed in Japanese Patent application Laid-open No. 7-307739 requires a concentrator for controlling data transmission, and therefore, there is an approximate similar problem to the communication system shown in FIG. 8.

### SUMMARY OF THE INVENTION

In view of the above, it is an object of the present invention to provide a communication system linking between user terminals, a user terminal connecting unit, and a communication method used in the communication system capable of reducing the number of input sections and the number of output sections in each unit with the minimum number of connection cables among the user terminal connecting units with respect to the increase of units, and capable of making the configuration thereof more simple in both cases where the common unit is unnecessary and the common unit is used.

According to a first aspect of the present invention, there is provided a communication system linking between user terminals including a plurality of user terminal connecting units for transmitting and receiving communication data to/from directed user terminals among a plurality of user terminals and for transmitting and receiving communication data among a user terminal connecting unit all of other user terminal connecting units and a communication line for transmitting and receiving the communication data between the user terminal connecting units:

wherein each of the user terminal connecting units converts the communication data from the directed user terminals into a signal light to be transmitted having a wavelength unique to each of the user terminal connecting units and transmits the signal light to all of other user terminal connecting units via the communication line; and while converting transmission/reception information showing a transmission/reception status of the communication data in the user terminal connecting unit into a control light having a predetermined wavelength different from a wavelength of the signal light to be transmitted and transmitting the control light to all of other user terminal connecting units via the communication line at a predetermined timing set uniquely to each of the user terminal connecting units, receives the signal light and the control light from another user terminal connecting unit via the communication line, converts the control light into the transmission/reception information directed to each of the user terminal connecting units, selects each of the signal lights based on the transmission/reception information and converts the selected signal light into the communication data, transmits the communication data to a corresponding user terminal, and controls transmission of the signal light based on the transmission/reception information.

In the foregoing, each of the user terminal connecting units may be preferably configured to include:

a first electronic-photo signal converter for converting the communication data from the directed user terminals as an electric signal into the signal light to be transmitted having the wavelength set unique to each of the user terminal connecting units;

a second electronic-photo signal converter for converting the transmission/reception information showing a transmission/reception status of the communication data in the user terminal connecting unit as an electric signal into the control light having a predetermined wavelength set different from the wavelength of the signal light to be transmitted;

a timing setting section for setting an output timing of the control light set uniquely to each of the user terminal connecting units;

an optical transmission section for wavelength-division-multiplexing the signal light and the control light and transmitting the signal light and the control light to all of other user terminal connecting units;

an optical signal receiving section for receiving the signal light and the control light from another user terminal connecting unit via the communication line;

a light wavelength demultiplexer for demultiplexing the signal lights and the control light received by the optical signal receiving section into each of different wavelengths;

an optical selection section for selecting a signal light of a user terminal connecting unit to be a transmission source from signal lights demultiplexed by the light wavelength demultiplexer;

a first photo-electronic signal converter for converting the selected signal light into communication data as an electric signal;

a communication data transmission section for transmitting the communication data to the corresponding user terminal;

a second photo-electronic signal converter for converting the control light demultiplexed by the light wavelength demultiplexer into the transmission/reception information directed to each of the user terminal connecting units as an electric signal; and

a signal light transmission control section for generating the wavelength selection signal based on the transmission/reception information and for controlling transmission of the signal light.

Also each of the user terminal connecting units may be preferably configured to include:

a first electronic-photo signal converter for converting the communication data from the directed user terminals as an electric signal into the signal light to be transmitted having the wavelength set unique to each of the user terminal connecting units;

a second electronic-photo signal converter for converting the transmission/reception information showing a transmission/reception status of the communication data in the user terminal connecting unit as an electric signal into the control light having a predetermined wavelength set different from the wavelength of the signal light to be transmitted;

a timing setting section for setting an output timing of the control light uniquely to each of the user terminal connecting units;

an optical transmission section for wavelength-division-multiplexing the signal light and the control light and transmitting the signal light and the control light to the communication line;

a light wavelength demultiplexer for receiving a signal light and a control light from another user terminal connecting unit via the communication line and demultiplexing the signal light and the control light into each of different wavelengths;

an optical selection section for selecting a signal light of a user terminal connecting unit to be a transmission source from signal lights demultiplexed by the light wavelength demultiplexer;

a first photo-electronic signal converter for converting the selected signal light into communication data;

a communication data transmission section for transmitting the communication data to the corresponding user terminal;

a second photo-electronic signal converter for converting the control light demultiplexed by the light wavelength demultiplexer into the transmission/reception information directed to each of the user terminal connecting units; and

a signal light transmission controlling section for generating the wavelength selection signal based on the transmission/reception information and for controlling transmission of the signal light;

and wherein the communication line includes a common unit for transmitting the signal light and the control light transmitted from the optical signal transmitting section in the user terminal connecting unit to all of other user terminal connecting units.

Also, the signal light transmission controlling section may be preferably configured to include:

a reference timing generating section for generating a reference-timing signal in a predetermined cycle;

a wavelength selection determining section for generating the wavelength selection signal based on the transmission/reception information and for detecting an available status of the signal light;

a data output determining section for determining an output timing of the communication data in the predetermined cycle based on the available status of the signal light; and

a data output buffer section for controlling transmission of the signal light based on the output timing.

Also, the transmission/reception information may be preferably configured to include:

transmission destination information showing a user terminal connecting unit to be a transmission destination; and

transmission source information showing a user terminal connecting unit to be a transmission source;

and wherein the communication data transmitting section transmits the communication data to a user terminal connecting unit corresponding to the transmission destination information.

According to a second aspect of the present invention, there is provided a user terminal connecting unit for transmitting and receiving communication data to/from directed user terminals among a plurality of user terminals and for transmitting and receiving the communication data among a user terminal connecting unit and all of other user terminal connecting units via a communication line:

wherein the user terminal connecting unit converts the communication data from the directed user terminals into a signal light to be transmitted having a wavelength unique to each of the user terminal connecting units and transmits the signal light to all of other user terminal connecting units via the communication line; and while converting transmission/reception information showing a transmission/reception status of the communication data in the user terminal connecting unit into a control light having a predetermined wavelength different from a wavelength of the signal light to be transmitted and transmitting the control light to all of other user terminal connecting units via the communication line at a predetermined timing set uniquely to the user terminal connecting unit, receives the signal light and the control light via the communication line, converts the control light into the transmission/reception information directed to each of the user terminal connecting units, selects each of the signal lights based on the transmission/reception information and converts the selected signal light into communication data, transmits the communication data to a corresponding user terminal, and controls transmission of the signal light based on the transmission/reception information.

According to a third aspect of the present invention, there is provided a communication method used in a communication system linking between user terminals including a plurality of user terminal connecting units for transmitting and receiving communication data to/from directed user terminals among a plurality of user terminals and for transmitting and receiving the communication data among a user terminal connecting unit and all of the other user terminal connecting units and a communication line for transmitting and receiving the communication data between the user terminal connecting units:

wherein each of the user terminal connecting units converts the communication data from the directed user terminals into a signal light to be transmitted having a wavelength unique to each of the user terminal connecting units and transmits the signal light to all of other user terminal connecting units via the communication line; and while converting transmission/reception information showing a transmission/reception status of the communication data in the user terminal connecting unit into a control light having a predetermined wavelength different from a wavelength of the signal light to be transmitted and transmitting the control light to all of other user terminal connecting units via the communication line at a predetermined timing set uniquely to each of the user terminal connecting units, receives the signal light and the control light from another user terminal connecting unit via the communication line, converts the control light into the transmission/reception information directed to each of the user terminal connecting units, selects each of the signal lights based on the transmission/reception information and converts the selected signal light into the communication data, transmits the communication data to a corresponding user terminal, and controls transmission of the signal light based on the transmission/reception information.

With these configurations, since each user terminal connecting unit converts each communication data into the signal light to be transmitted having a wavelength set uniquely to each user terminal connecting unit, the communication system is configured by sequentially cascade-connecting respective user terminal connecting units via the communication cable. Therefore, when a communication unit is added, an increase of communication cables is reduced, so that costs can be reduced and working for adding the user terminal connecting unit can be reduced. Further, since transmission of each communication data of each user terminal connecting unit is controlled by the control light, it is unnecessary to add a communication line exclusive to the control signal between user terminal connecting units. Therefore, each user terminal connecting unit can be configured relatively simply and costs can be reduced.

Also, since each user terminal connecting unit, after selecting the signal light of the user terminal connecting unit to be the transmission source, electrically-optically converts the signal light in the first photo-electronic signal converter, the number of electronic-photo signal converters and photo-electronic signal converters is relatively small and the communication system can be made relatively small regardless of the number of user terminal connecting units. Also, since the communication line is provided with the common unit for transmitting the signal light and the control signal transmitted from the optical transmission section in the user terminal connecting unit to all of the other user terminal connecting units, the optical transmission section becomes simple, no optical signal receiving section is needed, and the common unit is simple. Therefore, the communication system can be configured relatively simple.

### BRIEF DESCRIPTION OF THE DRAWINGS

The above and other objects, advantages, and features of the present invention will be more apparent from the following description taken in conjunction with the accompanying drawings in which:

FIG. 1 is a block diagram showing an electrical configuration of a communication system linking between user terminals according to a first embodiment of the present invention;

FIG. 2 is a timing chart for explaining an operation of the communication system shown in FIG. 1;

FIG. 3 is a block diagram showing an optical signal block as an essential part of a user terminal connecting unit according to a second embodiment of the present invention;

FIG. 4 is a; a block diagram showing an essential part of a user terminal connecting unit according to a third embodiment of the present invention;

FIG. 5 is a block diagram showing an essential part of a user terminal connecting unit according to a fourth embodiment of the present invention;

FIG. 6 is a block diagram showing an electrical configuration of an essential part of a communication system according to a fifth embodiment of the present invention;

FIG. 7 is a schematic block diagram showing a conventional communication system; and

FIG. 8 is a schematic block diagram showing another conventional communication system.

### DETAILED DESCRIPTION OF THE PREFERRED EMBODIMENTS

Best modes for carrying out the present invention will be described in further detail using various embodiments with reference to the accompanying drawings.

A communication system is provided in which each user terminal connecting unit converts each data signal into each optical signal of a wavelength set uniquely for each user terminal connecting unit and applies Wavelength Division Multiplexing (WDM) to the optical signal so as to be transmitted, and respective user terminal connecting units are sequentially cascade-connected via connection cables (fiber-optic cables).

### First Embodiment

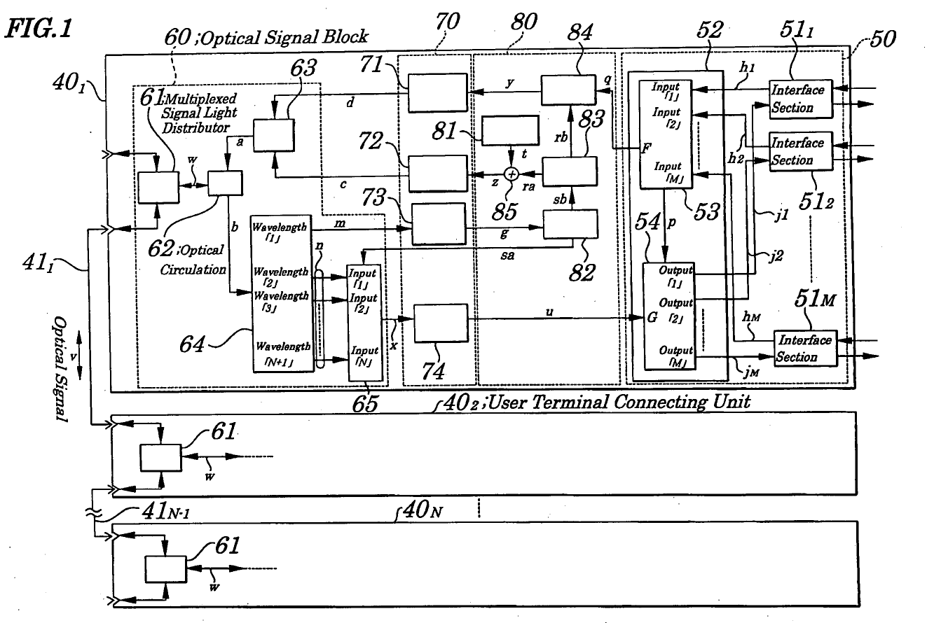

FIG. 1 is a schematic block diagram showing an electrical configuration of a communication system according to the first embodiment of the present invention.

The communication system according to the first embodiment, as shown in FIG. 1, is provided with user terminal connecting units 40₁, 40₂, . . . , 40_{N} and connection cables 41₁, 41₂, . . . , 41_{N} made up of optical fibers. The user terminal connecting user terminal connecting unit 40₁ is provided with a data switching block 50, an optical signal block 60, an photo-electronic converting block 70, and a data switching control block 80. The data switching block 50 is provided with M-pieces (M: integer) of interface sections 51₁, 51₂, . . . , 51_{M} and a data switching section 52. Each of the interface sections 51₁, 51₂, . . . , 50_{M} transmits/receives a client signal (communication data) to/from each of user terminals such as personal computers (not shown). Received data is output to the data switching section 52 as data signals h₁, h₂, . . . , h_{M} and data signals j₁, j₂, . . . , j_{M} from the data switching section 52 are transmitted as transmission data. The client signal includes a plurality of sub-data, and each sub-data is transmitted to each interface section 51₁, 51₂, . . . , 51_{M} corresponding to each transmission destination.

The data switching section 52 is provided with a data multiplexing section 53 and a data distributing section 54. The data multiplexing section 53 is provided with M-pieces of input sections (in FIG. 1, referred to as inputs) 1, 2, . . . , M and an output section F, applies time division multiplexing to the data signals h₁, h₂, . . . , h_{M} from one of the interface sections 51₁, 51₂, . . . , 51_{M}, outputs a signal addressed to another of interface sections 51₁, 51₂, . . . , 51_{M} in the same user terminal connecting user terminal connecting unit 40₁ as a data signal p, and outputs a signal addressed to the interface sections 51₁, 51₂, . . . , 51_{M} in the other user terminal connecting user terminal connecting units 40₂, . . . , 40_{N} as a data signal q. The data distributing section 54 is provided with an input section G and M-pieces of output sections (in FIG. 1, referred to input) 1, 2, . . . , M, receives a data signal u and the data signal p, and transmits the data signals j₁, j₂, . . . , j_{M} to corresponding user terminals via interface sections 51₁, 51₂, . . . , 51_{M} corresponded to sub-data destinations for respective sub-data.

The optical signal block 60 is provided with a multiplexed signal light distributor 61, an optical circulator 62, a light wavelength multiplexer 63, and a light wavelength demultiplexer 64. The multiplexed signal light distributor 61 receives an optical signal v from one two user terminal connecting units adjacent to the self-housed user terminal connect unit among the user terminal connecting user terminal connecting units 40₂, 40₃, . . . , 40_{N} and the outputs an optical signal w to the optical circulator 62, and also receives the optical signal v from an adjacent user terminal connect unit on one side and outputs the optical signal v to another adjacent user terminal connect unit on another side. Also, the multiplexed signal light distributor 61 outputs an optical signal w to one unit or two units adjacent to the unit. The optical circulator 62 receives an optical signal ‘a’ and outputs it to the multiplexed signal light distributor 61 as the optical signal w, and also receives the optical signal w and outputs it to the light wavelength demultiplexer 64 as an optical signal b. The light wavelength multiplexer 63 applies wavelength division multiplexing to an optical signal c and an optical signal d and outputs them to the optical circulator 62 as the optical signal ‘a’.

The multiplexed signal light distributor 61, the optical circulator 62, and the light wavelength multiplexer 63 make up an optical transmission section for transmitting the optical signal c and the optical signal d to all of the other user terminal connect units via the connection cables 41₁, 41₂, . . . , 41_{N-1}. The multiplexed signal light distributor 61 and the optical circulator 62 together make up an optical signal receiving section for receiving the optical signal c and the optical signal d from the other user terminal connect units via the connection cables 41₁, 41₂, . . . , 41_{N-1}. The light wavelength demultiplexer 64 demultiplexs the wavelength-division-multiplexed optical signal b into each wavelength, outputs an optical signal m of a wavelength ‘1’ and an optical signal n of wavelengths from ‘2’ to ‘N+1’. An optical selector 65 selects one signal among N-pieces of optical signals n demultiplexed in the light wavelength demultiplexer 64 on the basis of a wavelength selecting signal sa and outputs an optical signal x.

The photo-electronic converting block 70 is provided with electronic-photo signal converters 71, 72, and photo-electronic signal converter 73, 74. The electronic-photo signal converter 71 is made of a light-emitting diode or semiconductor laser for modulating a signal light to be transmitted of a predetermined wavelength with an input electrical signal, and also converts a data signal y into the optical signal d (signal light to be transmitted) of a wavelength K and outputs the optical signal d. The wavelength K is uniquely set to each unit and is one of the wavelength ‘2’ through the wavelength ‘N+1’. For example, the user terminal connecting user terminal connecting unit 40₁ outputs the optical signal d of the wavelength ‘2’, the user terminal connecting user terminal connecting unit 40₂ outputs the optical signal d of the wavelength ‘3’, and the user terminal connecting user terminal connecting unit 40_{N} outputs the optical signal d of the wavelength ‘N+1’. The electronic-photo signal converter 72 converts the data signal z into the optical signal c (light for control) of the wavelength ‘1’ different from the optical signal d (signal light to be transmitted), and then outputs the optical signal c. The data signal z includes transmission/reception information showing a status of transmitting and receiving the communication data of the user terminal connecting user terminal connecting user terminal connecting unit 40₁. The transmission/reception information includes transmission destination information showing a user terminal connect unit to be a transmission destination and transmission source information showing a user terminal connect unit to be a transmission source.

The photo-electronic signal converter 73 converts the optical signal m (light for control) of the wavelength ‘1’ demultiplexed in the light wavelength demultiplexer 64 into an electrical signal and outputs the electrical signal as a data signal g. The data signal g includes transmission/reception information. The photo-electronic signal converter 74 converts the optical signal x selected in the optical selector 65 into an electrical signal and outputs the electrical signal as the data signal u (communication data).

The data switching control block 80 is made up of a reference-timing generating section 81, a wavelength selection determining section 82, a data output determining section 83, a data output buffer section 84, and a multiplexing section 85. The data switching control block 80 serves as a signal light transmission control section for generating the wavelength section signal sa and for controlling transmission of the optical signal d based on the transmission/reception information. More specifically, the reference-timing generating section 81 generates a reference timing signal t at a predetermined cycle required to share the data signal z or the data signal g among all of the user terminal connecting user terminal connecting units 40₁, 40₂, . . . , 40_{N}. In order to use similar units, the reference-timing generating sections 81 may be arranged in all of the user terminal connecting user terminal connecting units 40₁, 40₂, . . . , 40_{N}. However, since one of the reference-timing generating sections 81 is required to be in operation, only the reference-timing generating section 81 in the user terminal connecting user terminal connecting unit 40₁ usually operates, the other reference-timing generating sections 81 in the user terminal connecting user terminal connecting units 40₂, . . . , 40_{N} are put into suspend mode. The reference timing signal t is multiplexed with the control signal ra in the multiplexing section 85 so as to be the data signal z, and is converted into the optical signal c of the wavelength ‘1’ in the electronic-photo signal converter 72.

The wavelength selection determining section 82 receives the data signal g in which the optical signal m of the wavelength ‘1’ is converted into the electrical signal in the photo-electronic signal converter 73, analyzes the transmission/reception information included in the data signal g, determines one of the wavelength ‘2’ through the wavelength ‘N+1’ to be selected and received in the user terminal connecting user terminal connecting units 40₁, 40₂, . . . , 40_{N}, and outputs the wavelength selection signal sa. Wavelength selection is dynamic, that is, the wavelength is repeatedly selected and changed in a short time. Also, the wavelength selection determining section 82 detects an available status of the signal light of the wavelength ‘K’ based on the transmission/reception information included in the data signal g. The data output determining section 83 receives a control signal sb, outputs the control signal ra for uniquely setting the output timing of the optical signal c, and, on the basis of the available status of the wavelength ‘K’ in the user terminal connecting user terminal connecting units 40₁, 40₂, . . . , 40_{N}, determines an output timing of the data signal y for every cycle of the reference timing signal t and outputs the output timing as a timing signal rb. The data output buffer section 84 is controlled on the basis of the timing signal rb, outputs the input data signal q as the data signal y when the timing signal rb is in an active mode, and executes buffering (reading) the data signal q when the timing signal rb is in a non-active mode.

The user terminal connecting user terminal connecting units 40₂, . . . , 40_{N} are similar to the user terminal connecting user terminal connecting unit 40₁. However, the number M of interface sections in each unit may be changed. The data output determining section 83 receives the control signal sb, and is different for every unit since the control signal is unique for setting the output timing of the optical signal c for each unit. The user terminal connecting user terminal connecting units 40₂, . . . , 40_{N} are sequentially cascade-connected via connection cables 41₁, 41₂, . . . , 41_{N}. The connection cables 41₁, 41₂, . . . , 41_{N} are made of optical fibers.

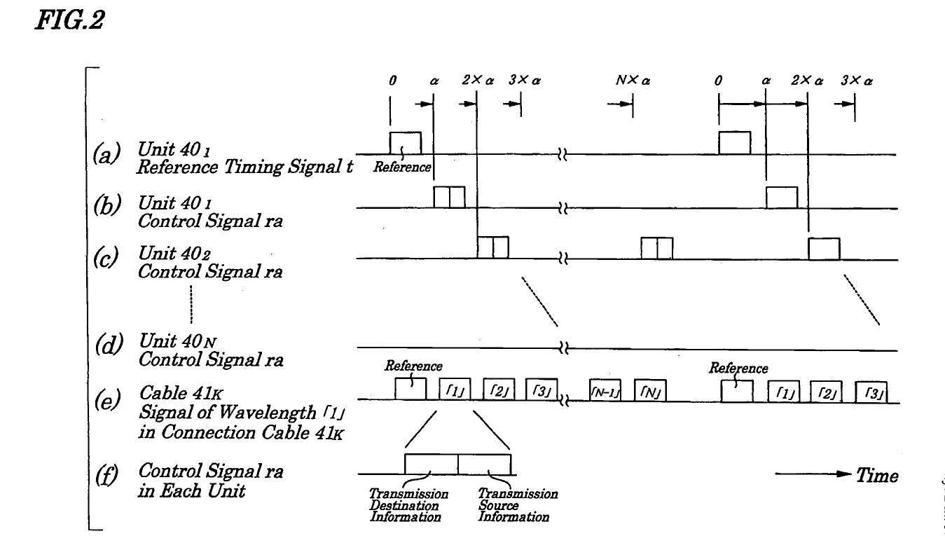

FIG. 2 is a timing chart for explaining an operation of the communication system shown in FIG. 1, where a vertical axis shows existences of signals and a horizontal axis shows time.

Referring to FIG. 2, explanations will be given of a communication method used in the communication system according to the first embodiment.

In the communication system, each of the user terminal connecting user terminal connecting units 40₁, 40₂, . . . , 40_{N} converts communication data from directed user terminals into an optical signal d to be transmitted in which an unique wavelength is set to one of the wavelengths of ‘2’ through ‘N+1’, transmits the optical signal to all of the user terminal connecting units via the connection cables 41₁, 41₂, . . . , 41_{N-1}, converts the transmission/reception information showing the transmission/reception status of the communication data in the unit into the optical signal c of which- the wavelength is set to ‘1’ different from that of the optical signal d, and transmits the optical signal to all of the other user terminal connect units via the connection cables 41₁, 41₂, . . . , 41_{N-1} at the uniquely set timing, while receiving each optical signal d and each optical signal c from another user terminal connect unit via connection cables 41₁, 41₂, . . . , 41_{N-1} converting the optical signal c into transmission/reception information corresponding to each unit, selecting the optical signal d on the basis of the transmission/reception information and converting the optical signal d into the communication data, transmitting the communication data to a designated user terminal, and controlling transmission of the optical signal d on the basis of the transmission/reception information.

More specifically, each of the user terminal connecting user terminal connecting units 40₁, 40₂, . . . , 40_{N} generates two optical signals, that is, the optical signal c of the wavelength ‘1’ from the electronic-photo signal converter 72 and the optical signal d of the wavelength ‘K’ from the electronic-photo signal converter 71. The wavelength ‘K’ is one of the wavelength of ‘2’ through the wavelength of ‘N+1’ and is changed in each of the user terminal connecting user terminal connecting units 40₁, 40₂, . . . , 40_{N}. In the user terminal connecting user terminal connecting unit 40₁, the optical signals c and d pass through the light wavelength multiplexer 63, the optical circulator 62, the multiplexed signal light distributor 61, and the connection cables 41₁, 41₂, . . . , 41_{N-1}, pass through the multiplexed signal light distributor 61 and the optical circulator 62 in the other user terminal connecting user terminal connecting units 40₂, . . . , 40_{N}, and reach the light wavelength demultiplexer 64. In each of the user terminal connecting user terminal connecting units 40₁, 4₂, . . . , 40_{N}, the optical selector 65 selects one of the wavelength ‘2’ through the wavelength ‘N+1’, that is, each optical signal d in each of the user terminal connecting user terminal connecting units 40₁, 40₂, . . . , 40_{N}, that is to say, the data signal y is selected.

For example, when sub-data is transmitted from a transmitting user terminal connecting user terminal connecting unit 40_{P} to a receiving user terminal connecting user terminal connecting unit 40_{Q}, in the data output buffer 84 in the user terminal connecting user terminal connecting unit 40_{P}, sub-data addressed to the user terminal connecting user terminal connecting unit 4_{Q} is added to the data signal y, and, in the electronic-photo signal converter 71, the data signal y is converted into the optical signal d of the wavelength ‘P+1’. Then, the optical signal d is input to the user terminal connecting user terminal connecting unit 40_{Q} through the light wavelength multiplexer 63, the optical circulator 62, the multiplexed signal light distributor 61, and the connection cables 41₁, 41₂, . . . , 41_{N-1} and is demultiplexed into each of different wavelengths in the light wavelength demultiplexer 64 via the multiplexed signal light distributor 61 and the optical circulator 62 in the user terminal connecting user terminal connecting unit 40_{Q}, so that the optical signal n of the wavelengths ‘2’ through ‘N+1’ is output. The optical signal n is input to the optical selector 65, and an optical signal x of a wavelength ‘P+1’ is selected and output. The optical signal x is converted into a data signal in the photo-electronic signal converter 74, and sub-data addressed to the user terminal connecting user terminal connecting unit 40_{Q} is obtained.

In this case, in the user terminal connecting user terminal connecting unit 40_{Q}, it is necessary to judge that the sub-data addressed to the user terminal connecting user terminal connecting unit 40_{Q} has been received in order to select the optical signal x of the wavelength ‘P+1’. Also, the optical signal d in the user terminal connecting user terminal connecting units 40₁, 40₂, . . . , 40_{N} is common in all user terminal connecting user terminal connecting units 40₁, 40₂, . . . , 40_{N} to be transmission destinations, and since one unit to be a transmission source is selected by the optical selector 65 once, it is necessary to execute transmission control for each optical signal d in each of the user terminal connecting user terminal connecting units 4₁, 40₂, . . . , 40_{N}. In the first embodiment, the optical signal of the wavelength ‘1’ is used for this purpose, and the data switching control block 80 including the reference-timing generating section 81, the wavelength selection determining section 82, the data output determining section 83, and the data output buffer section 84 performs this control.

More specifically, as shown in FIG. 2, the reference timing signal is periodically generated from the reference timing generating section 81 in the user terminal connecting user terminal connecting unit 40₁, as shown in (a) of FIG. 2. The reference timing generating sections 81 in the other user terminal connecting user terminal connecting units 40₂, . . . , 40_{N} are not needed to be in operation so as to be paused. Further, as shown in (b) to (d) of FIG. 2, the data output determining section 83 outputs the control signal ra at a time ‘Nα’ (α: predetermined time) which is unique for each unit from a time position where the reference timing signal t generates on a time base. With this operation, as shown in (e) of FIG. 2, all transmission/reception information of all the user terminal connecting user terminal connecting units 40₁, 40₂, . . . , 40_{N} appears like time division for every cycle of the reference timing signal t in the optical signal of the wavelength ‘1’ through the connection cable 41k (k: 1, . . . , N−1) and in the optical signal m (wavelength ‘1’) in each of the user terminal connecting user terminal connecting units 40₁, 40₂, . . . , 40_{N}.

As information output from the data output determining section 83 in each of the user terminal connecting user terminal connecting units 40₁, 40₂, . . . , 40_{N} as the control signal ra, information of a transmission destination unit while the unit outputs the sub-data (transmission destination information) and information of a transmission source unit while the unit selects and receives the sub-data (transmission source information) are needed. The transmission destination information is determined by the data output determining section 83 and is output as a timing signal rb. The transmission source information is determined by the wavelength selection determining section 82 and is output as the wavelength selection signal sa and the control signal sb. Therefore, the data output determining section 83, as shown in (e) of FIG. 2, outputs the transmission/reception information of the unit as the control signal sa on the basis of the transmission destination information and the transmission source information.

More specifically, in the wavelength selection determining section 82, the transmission destination information of all units included in the data signal g is referred, a transmission source unit in a case where a transmission destination unit is this unit is detected, and the wavelength selection signal sa for selecting the optical signal d is output from the transmission source unit. Also, in the data output determining section 83, the transmission source information included in the data signal g received by the wavelength selection determining section 82 is referred by receiving the control signal sb from the wavelength selection determining section 82. When there is a transmission source unit which has not been selected among the transmission destination units in which sub-data reaches the data output buffer section 84, a timing signal rb for transmitting sub-data to the non-selected unit is output. Further, when the transmission destination unit is selecting a transmission source unit, the sub-data is stored (buffered) in the data output buffer section 84. At this time, when there is sub-data for another transmission destination unit and the sub-data is capable of being transmitted, the sub-data is output with priority. In this way, the data output determining section 83 controls the transmission of sub-data.

Further, when the transmission destination selects no transmission source unit, there is a case where a plurality of transmission source units starts to output sub-data. In this case, a user terminal connecting unit for continuously outputting may be selected by competitive control. As a method, CSMA/CD (Carrier Sense Multiple Access/Collision Detection), D-channel control in ISDN-BRI (Integrated Services Digital Network-Basic Rate Interface) or the like is used.

As described above, according to the first embodiment, since each of the user terminal connecting user terminal connecting units 40₁, 40₂, . . . , 40_{N} converts each data signal y into the optical signal d of the wavelength uniquely set for each of user terminal connecting user terminal connecting units 40₁, 40₂, . . . , 40_{N}, the communication system is provided with the user terminal connecting user terminal connecting units 40₁, 40₂, . . . , 40_{N} sequentially cascade-connected via the connection cables 41₁, . . . , 41_{N-1}. Therefore, even if a user terminal connecting unit is added, an increase of connection cables is reduced, costs are reduced, and work for adding the unit is reduced. Since transmission of each data signal y in each of the user terminal connecting user terminal connecting units 40₁, 40₂, . . . , 40_{N} is controlled by the optical signal c (control signal), it is unnecessary to arrange a dedicated connection cable for only the control signal among the user terminal connecting user terminal connecting units 40₁, 40₂, . . . , 40_{N}. Therefore, the configuration of each unit is simple, and costs are reduced. After the optical signal block 60 in each of the user terminal connecting user terminal connecting units 40₁, 40₂, . . . , 40_{N} selects an optical signal n for the transmission source unit, the photo-electronic signal converter 74 optically-electrically converts the optical signal x. Therefore, since the number of electronic-photo signal converters and photo-electronic signal converters is relatively small like the electronic-photo signal converters 71, 72 and the photo-electronic signal converters 73, 74, a relatively small communication system can be configured regardless of the number of units.

### Second Embodiment

Next, explanations will be given of the second embodiment according to the present invention.

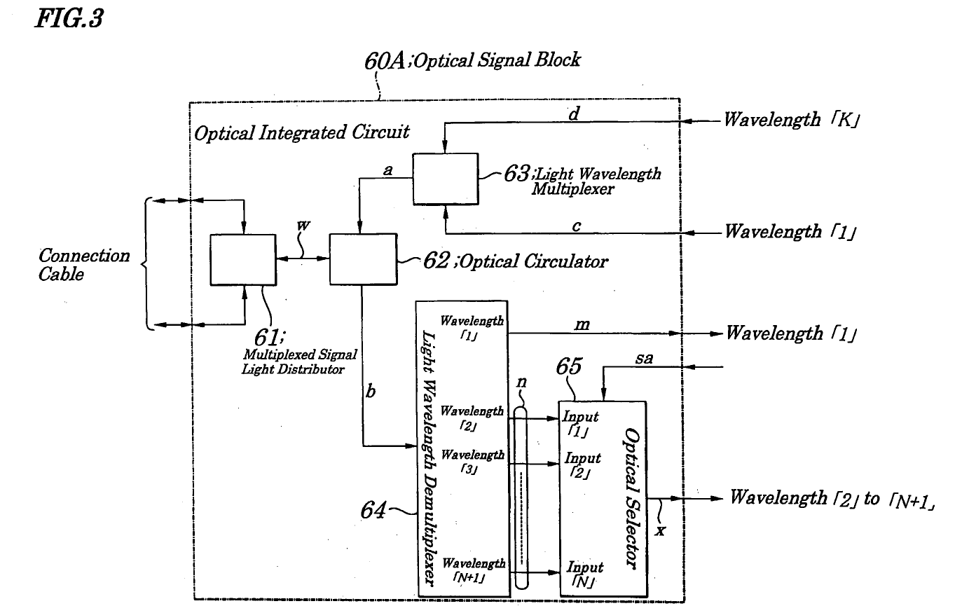

FIG. 3 is a block diagram showing an optical signal block as an essential part of a user terminal connecting unit according to a second embodiment of the present invention. In FIG. 3, the same numerals are applied to same elements in the first embodiment shown in FIG. 1.

In a user terminal connecting unit according to the second embodiment, as shown in FIG. 3, an optical signal block 60A different from the optical signal block 60 shown in FIG. 1 is arranged. In the optical signal block 60A, a multiplexed signal light distributor 61, an optical circulator 62, a light wavelength multiplexer 63, a light wavelength demultiplexer 64, and an optical selector 65 are integrated as an optical integrated circuit. The other parts are similar to those of FIG. 1. With this arrangement, each unit can be configured further simply and costs can be reduced in addition to the advantages described in the first embodiment.

### Third Embodiment

Next, explanations will be given of the third embodiment according to the present invention.

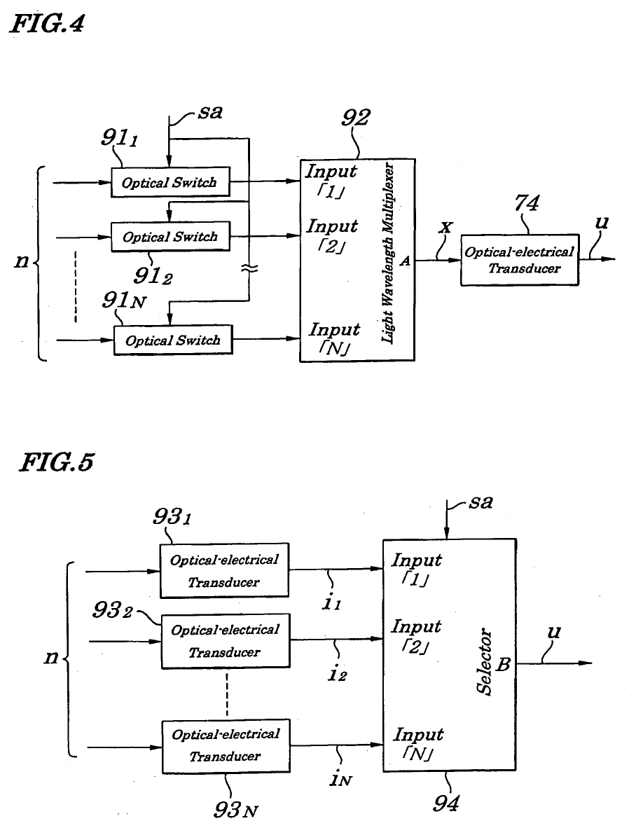

FIG. 4 is a; a block diagram showing an essential part of a user terminal connecting unit according to a third embodiment of the present invention.

In the unit according to the third embodiment, optical switches 91₁, 91₂, . . . , 91_{N} and a light wavelength multiplexer 92 are arranged instead of an optical selector 65 shown in FIG. 1. The optical switches 91₁, 91₂, . . . , 91_{N} conduct or interrupt an optical signal n from a light wavelength demultiplexer 64 for every wavelength in accordance with a wavelength selection signal sa. The light wavelength multiplexer 92 is provided with N-pieces of input sections (in FIG. 4, referred to ‘input’) ‘1’, ‘2’, . . . , ‘N’ and an output section A, and transmits the light output from the optical switches 91₁, 91₂, . . . , 91_{N} to the photo-electronic signal converter 74 as an optical signal x. The other parts are similar to those of FIG. 1.

According to the operation in this unit, the optical signal n is selected in accordance with the wavelength selection signal sa for every wavelength and is input to the light wavelength multiplexer 92, and the optical signal x is output from the light wavelength multiplexer 92. The optical signal x is converted into the data signal u in the photo-electronic signal converter 74. The other operations are executed similarly to those of the first embodiment, and the same advantages can be obtained.

### Fourth Embodiment

Next, explanations will be given of the fourth embodiment according to the present invention.

FIG. 5 is a block diagram showing an essential part of a user terminal connecting unit according to a fourth embodiment of the present invention.

In the unit according to the fourth embodiment, photo-electronic signal converters 93₁, 93₂, . . . , 93_{N} and a selector 94 are provided instead of an optical selector 65 and an photo-electronic signal converter 74 shown in FIG. 1. The photo-electronic signal converters 93₁, 93₂, . . . , 93_{N} convert the optical signal n from a light wavelength demultiplexer 64 into electrical signals i₁, i₂, . . . , i_{N} for every wavelength. The selector 94 is provided with N-pieces of input sections (in FIG. 5, referred to ‘input’) ‘1’, ‘2’, . . . , ‘N’ and an output section B, and selects the electrical signals i₁, i₂, . . . , i_{N} in accordance with a wavelength selection signal sa and outputs the electrical signals i₁, i₂, . . . , i_{N} as the data signal u.

According to the operation in this unit, in the photo-electronic signal converters 93₁, 93₂, . . . , 93_{N}, the optical signal n is converted into electrical signals i₁, i₂, . . . , i_{N}, in the selector 94, the electrical signals i₁, i₂, . . . , i_{N} are selected in accordance with the wavelength selection signal sa, and the data signal u is output from the selector 94. The other operations are executed similarly to the first embodiment, and the same advantages can be obtained. In this case, the number of photo-electronic signal converters increases in comparison with the first embodiment, however, the optical selector 65 is not needed, and therefore, there is an advantage concerning costs.

### Fifth Embodiment

Next, explanations will be given of the fifth embodiment according to the present invention.

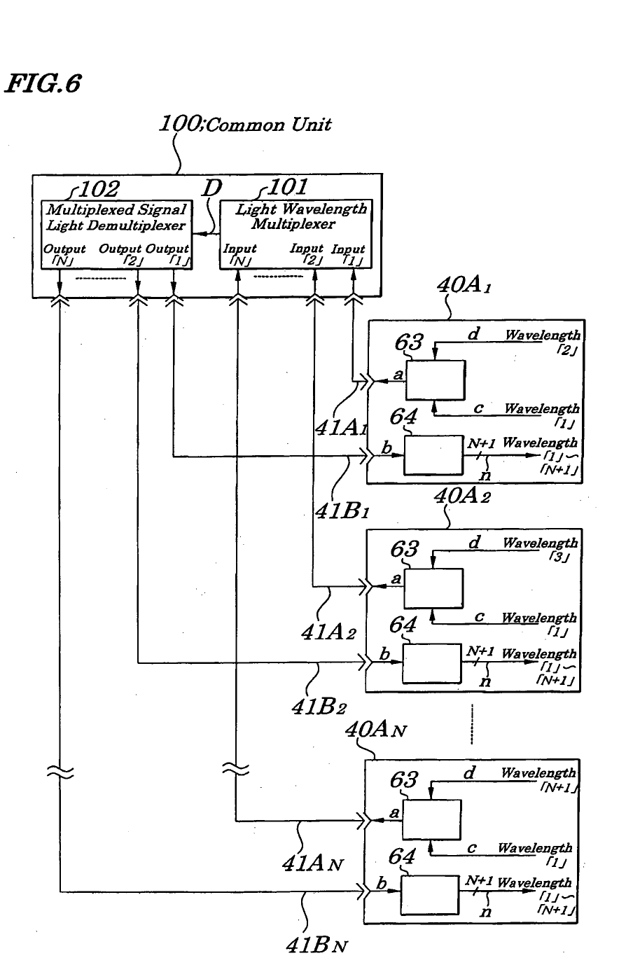

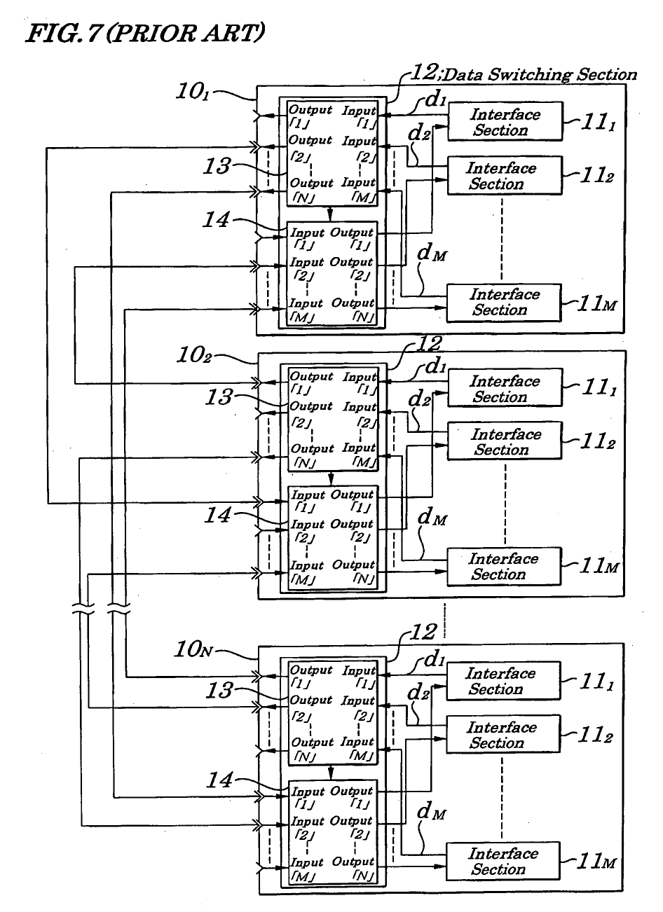

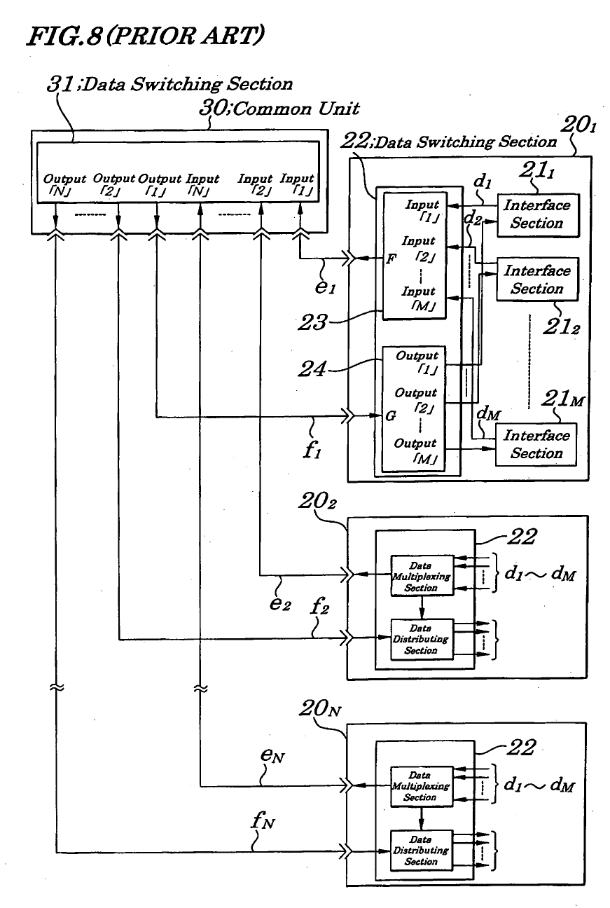

FIG. 6 is a block diagram showing an electrical configuration of an essential part of a communication system according to a fifth embodiment of the present invention.

In the communication system according to the fifth embodiment, user terminal connecting user terminal connecting units 40A₁, 40A₂, . . . , 40A_{N} different from user terminal connecting user terminal connecting units 40₁, 40₂, . . . , 40_{N} shown in FIG. 1 are arranged. The user terminal connecting user terminal connecting units 40A₁, 40A₂, . . . , 40A_{N} are connected to a common user terminal connecting unit 100 via connection cables 41A₁, 41A₂, . . . , 41A_{N} and connection cables 41B₁, 41B₂, . . . , 41B_{N}. The user terminal connecting user terminal connecting unit 40A₁ has no multiplexed signal light distributor 61 and no optical circulator 62 in the user terminal connecting user terminal connecting unit 40₁, shown in FIG. 1. The other parts are similar to those of the user terminal connecting user terminal connecting unit 40₁. The user terminal connecting user terminal connecting units 40A₂, . . . , 40A_{N} are similar to the user terminal connecting user terminal connecting unit 40A₁. The connection cables 41A₁, 41A₂, . . . , 41A_{N} and the connection cables 41B₁, 41B₂, . . . , 41B_{N} are optical fibers.

The common user terminal connecting unit 100 is provided with a light wavelength multiplexer 101 and a multiplexed signal light demultiplexer 102.

The light wavelength multiplexer 101 receives optical signals respectively from light wavelength multiplexers 63 in the user terminal connecting user terminal connecting units 40A₁, 40A₂, . . . , 40A_{N} via the connection cables 41A₁, 41A₂, . . . , 41A_{N}, multiplexes the optical signals to generate a multiplexed signal light D, and transmits the multiplexed signal light D to the multiplexed signal light demultiplexer 102. The multiplexed signal light demultiplexer 102 transmits the multiplexed signal light D to the user terminal connecting user terminal connecting units 40A₁, 40A₂, . . . , 40A_{N} via the connection cables 41B₁, 41B₂, . . . , 41B_{N}.

In the operation of the communication system, the optical signals ‘a’ from the light wavelength multiplexers 63 in the user terminal connecting user terminal connecting units 40A₁, 40A₂, . . . , 40A_{N} are respectively input to the light wavelength multiplexer 101 via the connection cables 41A₁, 41A₂, . . . , 41A_{N} and are multiplexed. The multiplexed signal light D is transmitted from the light wavelength multiplexer 101 to the multiplexed signal light demultiplexer 102. Then, the multiplexed signal light D is transmitted from the multiplexed signal light demultiplexer 102 to the user terminal connecting user terminal connecting units 40A₁, 40A₂, . . . , 40A_{N} via the connection cables 41B₁, 41B₂, . . . , 41B_{N}. The other operations are executed similarly to those of the first embodiment, and the same advantage can be obtained. The connection cables 41A₁, 41A₂, . . . , 41A_{N} and the connection cables 41B₁, 41B₂, . . . , 41B_{N} are needed, however, since no multiplexed signal light distributor 61 and no optical circulator 62 are needed in the user terminal connecting user terminal connecting units 40A₁, 40A₂, . . . , 40A_{N} and the common user terminal connecting unit 100 is simple, the communication system can be achieved with a relatively simple configuration.

The present invention can be applied to, in addition to a case where a network connected to a plurality of user terminals such as personal computers is arranged in a company, a data (trunk) communication system connected to a plurality of routers or a data (trunk) communication system configured for providing services to customers by a common carrier.

It is thus apparent that the present invention is not limited to the above embodiments but may be changed and modified without departing from the scope of the invention.

What is claimed is:

1. A communication system linking between user terminals comprising a plurality of user terminal connecting units for each transmitting and receiving communication data to/from directed user terminals among a plurality of user terminals and for transmitting and receiving the communication data to/from all of other user terminal connecting units and a communication line for transmitting and receiving the communication data between the user terminal connecting units:
wherein each of the user terminal connecting units converts the communication data from the directed user terminals into a signal light to be transmitted having a wavelength unique to each of the user terminal connecting units and transmits the signal light to all of other user terminal connecting units via the communication line; and while converting transmission/reception information showing a transmission/reception status of the communication data to/from all of said other user terminal connecting units into a control light having a predetermined wavelength different from a wavelength of the signal light to be transmitted and transmitting the control light to all of other user terminal connecting units via the communication line at a predetermined timing set uniquely to each of the user terminal connecting units, receives the signal light and the control light from another user terminal connecting unit via the communication line, converts the control light into the transmission/reception information directed to each of the user terminal connecting units, selects each of the signal lights based on the transmission/reception information and converts the selected signal light into the communication data, transmits the communication data to a corresponding user terminal, and controls transmission of the signal light based on the transmission/reception information.

2. The communication system linking between user terminals according to claim 1, wherein each of the user terminal connecting units comprises:
a first electronic-photo signal converter for converting the communication data from the directed user terminals into the signal light to be transmitted having the wavelength set unique to each of the user terminal connecting units;
a second electronic-photo signal converter for converting the transmission/reception information showing a transmission/reception status of the communication data in the self user terminal connecting unit into the control light having a predetermined wavelength set different from the wavelength of the signal light to be transmitted;
a timing setting section for setting an output timing of the control light uniquely set to each of the user terminal connecting units;
an optical signal transmitting section for wavelength-division-multiplexing the signal light and the control light and transmitting the signal light and the control light to all of other user terminal connecting units;
an optical signal receiving section for receiving the signal light and the control light from another user terminal connecting unit via the communication line;
a light wavelength demultiplexer for demultiplexing the signal light and the control light received by the optical signal receiving section into each of different wavelengths;
an optical signal selecting section for selecting a signal light of a user terminal connecting unit to be a transmission source from signal lights demultiplexed by the light wavelength demultiplexer;
a first photo-electronic signal converter for converting the selected signal light into communication data;
a communication data transmitting section for transmitting the communication data to the corresponding user terminal;
a second photo-electronic signal converter for converting the control light demultiplexed by the light wavelength demultiplexer into the transmission/reception information directed to each of the user terminal connecting units; and
a signal light transmission controlling section for generating the wavelength selection signal based on the transmission/reception information and for controlling transmission of the signal light.

3. The communication system linking between user terminals according to claim 1, wherein each of the user terminal connecting units comprises:
a first electronic-photo signal converter for converting the communication data from the directed user terminals as an electric signal into the signal light to be transmitted having the wavelength set unique to each of the user terminal connecting units;
a second electronic-photo signal converter for converting the transmission/reception information showing a transmission/reception status of the communication data in the user terminal connecting unit as an electric signal into the control light having a predetermined wavelength set different from the wavelength of the signal light to be transmitted;
a timing setting section for setting an output timing of the control light uniquely to each of the user terminal connecting units;
an optical signal transmitting section for wavelength-division-multiplexing the signal light and the control light and transmitting the signal light and the control signal to the communication line;
a light wavelength demultiplexer for receiving a signal light and a control light from another user terminal connecting unit via the communication line and demultiplexing the signal light and the control light into each of different wavelengths;
an optical signal selecting section for selecting a signal light of a user terminal connecting unit to be a transmission source from signal lights demultiplexed by the light wavelength demultiplexer;
a first photo-electronic signal converter for converting the selected signal light into communication data as an electric signal;
a communication data transmitting section for transmitting the communication data to the corresponding user terminal;
a second photo-electronic signal converter for converting the control light demultiplexed by the light wavelength demultiplexer into the transmission/reception information directed to each of the user terminal connecting units as an electric signal; and
a signal light transmission controlling section for generating the wavelength selection signal based on the transmission/reception information and for controlling transmission of the signal light;
and wherein the communication line comprises a common unit for transmitting the signal light and the control light transmitted from the optical signal transmitting section in the self user terminal connecting unit to all of other user terminal connecting units.

4. The communication system linking between user terminals according to claim 2, wherein the signal light transmission controlling section comprises:
a reference timing generating section for generating a reference timing signal in a predetermined cycle;
a wavelength selection determining section for generating the wavelength selection signal based on the transmission/reception information and for detecting an available status of the signal light;
a data output determining section for determining an output timing of the communication data in the predetermined cycle based on the available status of the signal light; and
a data output buffer section for controlling transmission of the signal light based on the output timing.

5. The communication system linking between user terminals according to claim 2, wherein the transmission/reception information comprises:
transmission destination information showing a user terminal connecting unit to be a transmission destination; and
transmission source information showing a user terminal connecting unit to be a transmission source;
and wherein the communication data transmitting section transmits the communication data to a user terminal connecting unit corresponding to the transmission destination information.

6. A user terminal connecting unit for transmitting and receiving communication data to/from directed user terminals among a plurality of user terminals and for transmitting and receiving communication data among a user terminal connecting unit and all of other user terminal connecting units via a communication line:
wherein the user terminal connecting unit converts the communication data from the directed user terminals into a signal light to be transmitted having a wavelength unique to each of the user terminal connecting units and transmits the signal light to all of other user terminal connecting units via the communication line; and while converting transmission/reception information showing a transmission/reception status of the communication data in the user terminal connecting unit into a control light having a predetermined wavelength different from a wavelength of the signal light to be transmitted and transmitting the control light to all of other user terminal connecting units via the communication line at a predetermined timing set uniquely to the user terminal connecting unit, receives the signal light and the control light via the communication line, converts the control light into the transmission/reception information directed to each of the user terminal connecting units, selects each of the signal lights based on the transmission/reception information and converts the selected signal light into communication data, transmits the communication data to a corresponding user terminal, and controls transmission of the signal light based on the transmission/reception information.

7. A communication method used in a communication system linking between user terminals comprising a plurality of user terminal connecting units for transmitting and receiving communication data to/from directed user terminals among a plurality of user terminals and for transmitting and receiving the communication data between one user terminal connecting unit and all of other user terminal connecting units and a communication line for transmitting and receiving the communication data between the user terminal connecting units:
wherein each of the user terminal connecting units converts the communication data from the directed user terminals into a signal light to be transmitted having a wavelength unique to each of the user terminal connecting units and transmits the signal light to all of other user terminal connecting units via the communication line; and while converting transmission/reception information showing a transmission/reception status of the communication data in the user terminal connecting unit into a control light having a predetermined wavelength different from a wavelength of the signal light to be transmitted and transmitting the control light to all of other user terminal connecting units via the communication line at a predetermined timing set uniquely to each of the user terminal connecting units, receives the signal light and the control light from another user terminal connecting unit via the communication line, converts the control light into the transmission/reception information directed to each of the user terminal connecting units, selects each of the signal lights based on the transmission/reception information and converts the selected signal light into the communication data, transmits the communication data to a corresponding user terminal, and controls transmission of the signal light based on the transmission/reception information.

8. The communication system linking between user terminals according to claim 1, wherein each of the user terminal connecting units comprises:
a first electronic-photo signal converter for converting the communication data from the directed user terminals as an electric signal into the signal light to be transmitted having the wavelength set unique to each of the user terminal connecting units;
a second electronic-photo signal converter for converting the transmission/reception information showing a transmission/reception status of the communication data in the user terminal connecting unit as an electric signal into the control light having a predetermined wavelength set different from the wavelength of the signal light to be transmitted;
a timing setting means for setting an output timing of the control light uniquely set to each of the user terminal connecting units;
an optical transmitting means for wavelength-division-multiplexing the signal light and the control light and transmitting the signal light and the control light to all of other user terminal connecting units;
an optical receiving means for receiving the signal light and the control light from another user terminal connecting unit via the communication line;
a light wavelength demultiplexer for demultiplexing the signal light and the control light received by the optical receiving means into each of different wavelengths;
an optical selecting means for selecting a signal light of a user terminal connecting unit to be a transmission source from signal lights' demultiplexed by the light wavelength demultiplexer;
a first photo-electronic signal converter for converting the selected signal light into communication data as an electric signal;
a communication data transmitting means for transmitting the communication data to the corresponding user terminal;
a second photo-electronic signal converter for converting the control light demultiplexed by the light wavelength demultiplexer into the transmission/reception information directed to each of the user terminal connecting units as an electric signal; and
a signal light transmission controlling means for generating the wavelength selection signal based on the transmission/reception information and for controlling transmission of the signal light.

9. The communication system linking between user terminals according to claim 1, wherein each of the user terminal connecting units comprises:
a first electronic-photo signal converter for converting the communication data from the directed user terminals as an electric signal into the signal light to be transmitted having the wavelength set unique to each of the user terminal connecting units;
a second electronic-photo signal converter for converting the transmission/reception information showing a transmission/reception status of the communication data in the user terminal connecting unit as an electric signal into the control light having a predetermined wavelength set different from the wavelength of the signal light to be transmitted;
timing setting means for setting an output timing of the control light uniquely to each of the user terminal connecting units;
optical transmitting means for wavelength-division-multiplexing the signal light and the control light and transmitting the signal light and the control signal to the communication line;
a light wavelength demultiplexer for receiving a signal light and a control light from another user terminal connecting unit via the communication line and demultiplexing the signal light and the control light into each of different wavelengths;
optical selecting means for selecting a signal light of a user terminal connecting unit to be a transmission source from signal lights demultiplexed by the light wavelength demultiplexer;
a first photo-electronic signal converter for converting the selected signal light into communication data as an electric signal;
communication data transmitting means for transmitting the communication data to the corresponding user terminal;
a second photo-electronic signal converter for converting the control light demultiplexed by the light wavelength demultiplexer into the transmission/reception information directed to each of the user terminal connecting units as an electric signal; and
signal light transmission controlling means for generating the wavelength selection signal based on the transmission/reception information and for controlling transmission of the signal light:
and wherein the communication line comprises a common unit for transmitting the signal light and the control light transmitted from the optical transmitting means in the user terminal connecting unit to all of other user terminal connecting units.

10. The communication system linking between user terminals according to claim 8, wherein the signal light transmission controlling means comprises:
a reference timing generating means for generating a reference timing signal in a predetermined cycle;
a wavelength selection determining means for generating the wavelength selection signal based on the transmission/reception information and for detecting an available status of the signal light;
a data output determining means for determining an output timing of the communication data in the predetermined cycle based on the available status of the signal light; and
a data output buffer means for controlling transmission of the signal light based on the output timing.

11. The communication system linking between user terminals according to claim 8, wherein the transmission/reception information comprises:
transmission destination information showing a user terminal connecting unit to be a transmission destination; and
transmission source information showing a user terminal connecting unit to be a transmission source:
and wherein the communication data transmitting means transmits the communication data to a user terminal connecting unit corresponding to the transmission destination information.
